(19) United States
(12) Patent Application Publication
(10) Pub. No.: US 2025/0172462 A1
(43) Pub. Date: May 29, 2025

(54) Low Temperature Processing of Cryoprotected Tissues

(71) Applicant: Genentech, Inc., South San Francisco, CA (US)

(72) Inventor: Mike Reichelt, San Mateo, CA (US)

(73) Assignee: Genentech, Inc., South San Francisco, CA (US)

(21) Appl. No.: 19/038,232

(22) Filed: Jan. 27, 2025

Related U.S. Application Data
(63) Continuation of application No. PCT/US2023/071334, filed on Jul. 31, 2023.
(60) Provisional application No. 63/394,459, filed on Aug. 2, 2022.

(51) Int. Cl. G01N 1/30; G01N 1/28; G01N 1/31

(52) U.S. Cl. CPC G01N 1/30; G01N 1/286; G01N 1/31; G01N 2001/2873; G01N 2001/302

(57) ABSTRACT

The present disclosure relates to novel procedures for cryoprotection of tissues for imaging procedures such as correlative light and electron microscopy (CLEM) and immunogold electron microscopy (iEM) and fluorescence imaging. The procedures combine perfusion fixation with cryoprotection of harvested organs or tissues in dimethylsulfoxide (DMSO) and freeze substitution in an organic solvent, to reliably freeze and process larger tissue blocks while preserving ultrastructure for image analysis.

### CROSS-REFERENCE TO RELATED APPLICATIONS

This application is a continuation of International Application No. PCT/US2023/071334, filed Jul. 31, 2023, which claims the benefit of priority of U.S. Provisional Application No. 63/394,459, filed Aug. 2, 2022, the contents of which are incorporated herein by reference in their entireties.

### FIELD

The present disclosure relates to novel procedures for cryoprotection of tissues for imaging procedures such as correlative light and electron microscopy (CLEM) and immunogold electron microscopy (iEM) and fluorescence imaging. The procedures combine perfusion fixation with cryoprotection of harvested organs or tissues in dimethylsulfoxide (DMSO) and freeze substitution in an organic solvent, to reliably freeze and process larger tissue blocks while preserving ultrastructure for image analysis.

### BACKGROUND

Correlative light and electron microscopy (CLEM) and immunogold electron microscopy (iEM) are important methods in the arsenal of experimental strategies applied in the field of drug discovery and safety assessment of potential therapeutic molecules. The precise localization of drug targets and drug candidates in cultured cells, organoids and mammalian tissues plays a major role in elucidating the mechanism of action of a drug candidate and to better understand safety concerns and pathologies associated with potential therapeutic molecules.

Cryofixation by plunge freezing or high pressure freezing followed by freeze-substitution and low temperature processing of samples into Lowicryl® resins has been used to prepare specimens for CLEM and iEM, and may better preserve ultrastructural detail, membrane contrast, epitopes and fluorescence emission compared to other, prior methods. This method of cryofixation, however, is only reliable for very small and thin samples (below 400 μm) and is not suitable for most mammalian tissues and organoids without first thin-sectioning by vibratomy, which can be challenging when regions of interest and histopathologies are ill defined or very small and focal. For example, when such thin samples are imaged, for example, to understand biological processes such as drug localization in tissues, information derived from the images may be relatively limited. In addition, harvesting and dissecting of organs and tissue from mammalian animals (mouse, rat, monkey) and vibratomy of tissues generally requires chemical pre-fixation of the tissues via perfusion fixation or drop fixation to avoid artifacts from tissue decay, which can further limit the benefits of the method if a strong fixative is used.

More versatile methods of preparing tissues for CLEM and iEM and other imaging methods are, accordingly, needed.

### SUMMARY

The present disclosure provides, inter alia, a novel method of preparing samples for CLEM and iEM and related imaging uses, including fluorescence imaging. The methods, in some embodiments avoid the use of vibratomy and/or high pressure fixation, and allow for larger, thicker samples to be prepared and analyzed. In some embodiments, the methods herein allow high quality images of the localization of molecules such as drugs in cells, organelles, or tissues, and also allow for imaging a wider, larger selection of surrounding tissue, thus providing more thorough information about the interaction of the imaged molecules with cells in culture, for example. In some embodiments, the methods herein are also cheaper and simpler to perform due the lack of need for either high pressure equipment for fixing cells and/or the need for vibratomy equipment, which can be costly.

Methods herein include, for example, a method of cryoprotecting a tissue sample, comprising: (a) Exposing a tissue sample of 2 mm or less average thickness to a dimethyl sulfoxide (DMSO) solution; (b) Freezing the sample of (a) in liquid nitrogen; (c) Freeze-substituting the sample of (b); and (d) Adding an embedding resin compatible with temperatures of −60° C. to −80° C. to the sample of (c), and polymerizing the resin. In some cases, the tissue sample of (a) has an average thickness of 1.5 mm or less. In some cases, it has an average thickness of 1.0 mm or less. In some cases, it has an average thickness of 0.4 mm to 1.5 mm. In some cases, the tissue sample of (a) has an average thickness of at least 0.5 mm (such as, of 0.5-2 mm, of 0.5-1.5 mm, or of 0.5-1 mm). In some cases, the tissue sample of (a) has not been prepared via vibratomy, and/or wherein the sample has been manually prepared or sliced. In some cases, the tissue sample has been perfused with a light fixative, or has been obtained from a tissue or organ that has been perfused with a light fixative, and/or wherein the tissue sample has not been high pressure frozen. In some cases, the light fixative comprises 1-4% paraformaldehyde. In some cases, the sample of (b) is freeze-substituted with an acetone solution, such as 100% acetone, or a mixture of 100% acetone and at least one heavy metal stain such as uranyl acetate and/or osmium tetroxide. In some cases, the sample of (b) is freeze-substituted in a mixture of 100% acetone and 0.01-0.2% uranyl acetate, and optionally osmium tetroxide, such as 0.001% to 0.002% osmium tetroxide. In some cases, the embedding resin is a non-polar resin. In other cases, the embedding resin is a polar resin. In some cases, the embedding resin is an acrylate and methacrylate resin and/or wherein the resin is polymerized by ultraviolet light, such as at 360 nm wavelength. In some cases, the method further comprises staining the sample of (d), for example, with a fluorescent stain and/or a heavy metal stain, such as one or more of osmium, lead, or gold stains. In some cases, the method is conducted at atmospheric pressure. In some cases, the sample is a tissue block from a solid organ. In some cases, the method further comprises preparing the tissue sample of 2 mm or less average thickness by obtaining a tissue sample or organ that has been perfused with a light fixative and slicing the tissue sample or organ to an average thickness of 2 mm or less. In some cases, the method further comprises perfusing a tissue sample or organ in a light fixative and slicing the tissue sample or organ to an average thickness of 2 mm or less prior to step (a). In some cases, the DMSO solution comprises 40-60% DMSO, such as 40%, 45%, 50%, 55%, or 60% DMSO.

The disclosure herein also includes tissue samples prepared by such methods as above, or as otherwise disclosed herein.

The instant disclosure also includes kits for performing the methods as above or as otherwise described herein. Kits may comprise at least one of: a DMSO solution, a freeze substitution solution such as 100% acetone or a mixture of 100% acetone and at least one heavy metal stain such as uranyl acetate and/or osmium tetroxide, and an embedding resin, such as a polar or non-polar acrylate and methacrylate resin, wherein the resin is compatible with temperatures of −60° C. to −80° C., and optionally further comprising at least one of: a plate or chip for immersing the tissue sample in liquid nitrogen, a fluorescence and/or electron microscopy imaging slide, and instructions for use. The instant disclosure also includes systems for performing the methods above or as otherwise described herein. In some cases, a system automatically or semiautomatically performs the steps of the methods, such as: (a) Exposing a tissue sample of 2 mm or less average thickness to a dimethyl sulfoxide (DMSO) solution; (b) Freezing the sample of (a) in liquid nitrogen; (c) Freeze-substituting the sample of (b); and (d) Adding an embedding resin compatible with temperatures of −60° C. to −80° C. to the sample of (c), and polymerizing the resin. In some cases, a system performs steps (a) to (d) on at least one plate or chip.

Further methods herein include, for example, a method of imaging a tissue sample or a section of a tissue sample, wherein the tissue sample has an average thickness of 2 mm or less and has been prepared by a process comprising (a) exposing the sample to a dimethyl sulfoxide (DMSO) solution, (b) freezing the sample of (a) in liquid nitrogen, (c) freeze-substituting the sample of (b), and (d) adding an embedding resin compatible with temperatures of −60° C. to −80° C. to the sample of (c) and polymerizing the resin; the method comprising: performing fluorescence microscopy, electron microscopy, or a combination of both fluorescence microscopy and electron microscopy on the tissue sample or on the section of the tissue sample. In some cases, the tissue sample of (a) has an average thickness of 1.5 mm or less. In some cases, it has an average thickness of 1.0 mm or less. In some cases, it has an average thickness of 0.4 mm to 1.5 mm. In some cases, the tissue sample of (a) has an average thickness of at least 0.5 mm (such as, of 0.5-2 mm, of 0.5-1.5 mm, or of 0.5-1 mm). In some cases, the tissue sample of (a) has not been prepared via vibratomy, and/or wherein the sample has been manually prepared or sliced. In some cases, the tissue sample has been perfused with a light fixative, or has been obtained from a tissue or organ that has been perfused with a light fixative, and/or wherein the tissue sample has not been high pressure frozen. In some cases, the light fixative comprises 1-4% paraformaldehyde. In some cases, the sample of (b) is freeze-substituted with an acetone solution, such as 100% acetone, or a mixture of 100% acetone and at least one heavy metal stain such as uranyl acetate and/or osmium tetroxide. In some cases, the sample of (b) is freeze-substituted in a mixture of 100% acetone and 0.01-0.2% uranyl acetate, and optionally osmium tetroxide, such as 0.001% to 0.002% osmium tetroxide. In some cases, the embedding resin is a non-polar resin. In other cases, the embedding resin is a polar resin. In some cases, the embedding resin is an acrylate and methacrylate resin and/or wherein the resin is polymerized by ultraviolet light, such as at 360 nm wavelength. In some cases, the method further comprises staining the sample of (d), for example, with a fluorescent stain and/or a heavy metal stain, such as one or more of osmium, lead, or gold stains. In some cases, the method is conducted at atmospheric pressure. In some cases, the sample is a tissue block from a solid organ. In some cases, the method further comprises preparing the tissue sample of 2 mm or less average thickness by obtaining a tissue sample or organ that has been perfused with a light fixative and slicing the tissue sample or organ to an average thickness of 2 mm or less. In some cases, the method further comprises perfusing a tissue sample or organ in a light fixative and slicing the tissue sample or organ to an average thickness of 2 mm or less prior to step (a). In some cases, the DMSO solution comprises 40-60% DMSO, such as 40%, 45%, 50%, 55%, or 60% DMSO. In some cases, the imaging comprises electron microscopy, which, in turn, is correlated light and electron microscopy (CLEM) or immunogold electron microscopy or scanning electron microscopy (SEM), such as back-scattered electron scanning electron microscopy (BSE-SEM). In some cases, the method is capable of distinguishing the location of a drug molecule in or adjacent to a cell in the sample, such as, for example, a lipid-coated drug, an antisense drug, an antibody drug, a polypeptide drug, or a small molecule drug. In some cases, the method is performed on a section of the tissue sample with an average thickness of 300 nm to 1000 nm, such as 500 nm. In some cases, the method comprises performing fluorescence microscopy on the sample or on a section of the sample as well as electron microscopy, such as CLEM or immunogold electron microscopy or SEM or BSE-SEM.

Additional objects and advantages will be set forth in part in the description which follows, and in part will be understood from the description, or may be learned by practice. The objects and advantages will be realized and attained by means of the elements and combinations particularly pointed out in the appended claims. It is to be understood that both the foregoing general description and the following detailed description are exemplary and explanatory only and are not restrictive of the claims. The accompanying drawings, which are incorporated in and constitute a part of this specification, illustrate certain embodiments, and together with the description, serve to further explain certain principles described herein.

### BRIEF DESCRIPTION OF THE DRAWINGS

The present US provisional application includes at least one drawing executed in color. In the event that a nonprovisional or PCT application claiming priority to this US provisional application and incorporating the contents of this provisional application publishes in the future, copies of this provisional patent application including the color drawings will be provided by the Office upon request and payment of the necessary fee.

FIGS. 1A-G show imaging of colon (FIGS. 1A, 1, and 1C), colorectal cancer (FIGS. 1D and 1E), pancreas (FIG. 1F) and kidney (FIG. 1G) samples following preparation of the samples with methods described herein. Samples were stained with osmium tetroxide (OsO4) to stain lipids and cell membranes, uranyl acetate (UA) to stain proteins and nucleic acids, and lead citrate (LC) to enhance contrast between stained and unstained areas.

FIGS. 2A-2C show imaging of Langerhans islet cells in mouse pancreas in the presence of a fluorescent and gold double-stained anti-insulin antibody at 200× (FIG. 2A) or 250× (FIGS. 2B and 2C) magnification by either fluorescence (FIG. 2A) or BSE-SEM (FIG. 2B) or a combination of fluorescence and BSE-SEM (FIG. 2C) imaging.

FIGS. 2D-F show imaging of Langerhans islet cells in mouse pancreas in the presence of a fluorescent and gold double-stained anti-insulin antibody at 400× (FIG. 2D) or 1000× (FIGS. 2E and 2F) magnification by either fluorescence (FIG. 2D) or BSE-SEM (FIG. 2E) or a combination of fluorescence and BSE-SEM (FIG. 2F) imaging.

FIGS. 3A-3B show imaging of Langerhans islet cells in mouse pancreas in the presence of a fluorescent and gold double-stained anti-insulin antibody at 1000× (FIG. 3B) and 20,000× (FIG. 3A) magnification by fluorescence (FIG. 3A) and BSE-SEM (FIG. 3B).

FIG. 4 shows detection and localization of allele-specific oligonucleotide nanoparticles in ependymal cells of the chloroid plexus at 500× magnification by BSE-SEM after intracerebroventricular injection of the nanoparticles into mouse brains. Samples were prepared by methods described herein.

FIGS. 5A-E show detection and localization of allele-specific oligonucleotide nanoparticles in ependymal cells of the chloroid plexus at 400× (FIG. 5A), and at 5000× (FIGS. 5B and 5C), 15,000× (FIG. 5D), and 20,000× (FIG. 5E) magnification. Nanoparticles are identified using arrows in the images using a gold-labeled antibody specific to the nanoparticles. The encircled features in the upper portion of FIGS. 5B and 5C are shown in greater detail in FIGS. 5D and 5E, respectively.

### DETAILED DESCRIPTION OF PARTICULAR EMBODIMENTS

### I. Definitions

Unless otherwise defined, scientific and technical terms used in connection with the present invention shall have the meanings that are commonly understood by those of ordinary skill in the art.

In this application, the use of “or” means “and/or” unless stated otherwise. In the context of a multiple dependent claim, the use of “or” refers back to more than one preceding independent or dependent claim in the alternative only. Also, terms such as “element” or “component” encompass both elements and components comprising one unit and elements and components that comprise more than one subunit unless specifically stated otherwise.

As described herein, any concentration range, percentage range, ratio range or integer range is to be understood to include the value of any integer within the recited range and, when appropriate, fractions thereof (such as one tenth and one hundredth of an integer), unless otherwise indicated.

Units, prefixes, and symbols are denoted in their Système International de Unites (SI) accepted form. Numeric ranges are inclusive of the numbers defining the range. The headings provided herein are not limitations of the various aspects of the disclosure, which can be had by reference to the specification as a whole. Accordingly, the terms defined immediately below are more fully defined by reference to the specification in its entirety.

As utilized in accordance with the present disclosure, the following terms, unless otherwise indicated, shall be understood to have the following meanings:

The term “cryoprotection” or “cryoprotecting” refers to the process of protecting a sample, such as a tissue sample, from damage, for example to cellular structure or cellular integrity, that can occur due to freezing of the sample.

A “tissue sample” as used herein refers broadly to any sample from any organism that contains cells or tissues. A sample may be derived from a solid organ, such as by sectioning the organ, or from a part of an organ such as a piece of tissue, or from a cell culture, or the like.

As used herein, “freeze-substitution” or “freeze-substituting” refers to a process in which an organic solvent is used at very low temperature to effectively dissolve frozen water in and/or around a tissue sample at cold temperatures, thus substituting the water molecules with molecules of the organic solvent.

The term “average thickness” when applied to a tissue sample refers to the average, general thickness of the sample across the length of the sample, for example a tissue sample arranged on a slide. The numerical value of the average thickness incorporates experimental and observational error, which may be relatively large in this instance, in that many samples may be sliced manually rather than in a specialized instrument.

The term “vibratomy” refers to a specialized method of obtaining very thin sections of tissue of, for instance 0.4 mm or less in thickness, generally by use of a specialized vibratometer instrument.

The term “high pressure fixation” or “high pressure freezing” refers to a method of fixing organs or tissue samples by exposing them to both freezing temperatures and high pressures, significantly above atmospheric pressure, with the goal to preserve the organ or tissue without loss of ultrastructure.

The term “ultrastructure” refers to the cellular or organellar structures within a tissue sample. The term “epitope” herein refers to a binding site for an antibody, polypeptide, oligonucleotide, or other molecule that is intended to specifically target a particular molecule or structure in a cell. An epitope can comprise, for example, the specific binding location on the targeted molecule, or the specific binding location on the targeted structure of a cell, such as an organelle.

The term “perfusion fixation” or “chemical fixation” refers to a method of fixing organs or tissue samples in which a fixative chemical, such as formaldehyde or paraformaldehyde, is perfused into the blood vessels or related structures of the organ or tissue sample. In some embodiments, the fixative chemical then forms cross-links with the structural components of the organ or tissue, preserving their architecture.

As used herein, a “light fixative” is a fixative chemical that makes a light degree of crosslinks, such as single cross-links from one fixative molecule to molecules in the sample being fixed (e.g., paraformaldehyde), as opposed to more robust crosslinking, such as double crosslinks (i.e., “strong fixatives” such as glutaraldehyde or osmium tetroxide). An example of a light fixative is paraformaldehyde at 14%.

An “embedding resin” as described herein refers to a substance that is used to penetrate tissue samples on slides prior to imaging in order to fix the components of the tissue samples in place, for example, by polymerization of the resin after it has infiltrated the sample, and may allow the samples to be stored without degradation or movement of the ultrastructures and molecules to be imaged.

### II. Exemplary Methods of Cryoprotecting Tissue Samples

The present disclosure encompasses, for example, methods of preparing cryoprotected tissue samples as well as methods of using such cryoprotected tissue samples for fluorescence and/or electron microscopy. For example, such ultrastructural immunohistochemistry applications can ideally be used to identify cell types and organelles, and to localize biological processes involving cells and organelles, such as via localization of specific molecules involved in biological processes. In some cases, such applications can ideally be useful in understanding and evaluating the mechanisms of potential therapeutics. For instance, one goal of the present methods is to be able to localize potential drug targets in the sample, or localize therapeutics in the sample to see how they interact with, not only their target molecules, but other cellular structures as well. Such imaging applications rely on high quality tissue samples that preserve both ultrastructure and binding epitopes while allowing for appropriate labeling density in fluorescent and electron microscopy imaging methods. The present methods address a technical challenge in finding fixation and processing conditions that allow for the best compromise between labeling density and ultrastructure preservation in the sample.

One comparative method of preparing samples, for example, is by using high pressure and very low temperatures to fix the samples rather than by adding chemical fixatives (high pressure fixation). This method can have advantages in that, because the starting tissues are not chemically fixed, they are not subjected to crosslinking that could mask epitopes or impact ultrastructures, resulting in antigens being well preserved structurally with less background when performing fluorescence imaging. However, only small tissue samples can be frozen in this method, such as samples less than 400 μm in thickness, such as 100 μm to less than 400 μm. Such small sample sizes may be less useful for analysis. In addition, because the thickness of the samples must be so small, such samples must generally be prepared using vibratomy. Both vibratomy and high pressure fixation are expensive and require specialized instrumentation. In addition, there can be fixation artifacts due to freezing in the tissues.

In contrast, in the present disclosure, the inventor has found that cryoprotection of lightly chemically fixed tissues, such as with 1-4% paraformaldehyde, is simpler, cheaper, and allows for preparation of larger samples of about 1 mm thick. This allows for larger sections that can, in some cases, be imaged by wide field BSE-SEM imaging. The inventor has also found that such tissues can be stored for reasonable periods and retain good quality ultrastructure for imaging, when prepared according to methods herein. Because the present methods do not require either vibratomy or high pressure fixation, they are cheaper and simpler to perform. While use of chemical fixation can present challenges, such as risk of artifacts from chemical fixation of samples, as well as potential for loss of antigenicity, delocalization of antigens, increased background autofluorescence from presence of aldehyde, and dimming of GFP fluorescence, the inventor has found that methods herein result in relatively high quality fluorescence and electron microscopy images.

In some embodiments, methods herein comprise cryoprotecting a tissue sample, which, in some embodiments, has been fixed with a light fixative, such as 1-4% paraformaldehyde, and with a thickness of 2 mm or less on average, by first exposing the sample to a DMSO solution, then freezing the sample in liquid nitrogen, freeze substituting the sample frozen in liquid nitrogen, then adding a cold-temperature stable resin to the sample. For example, some embodiments comprise cryoprotecting a tissue sample by a method comprising (a) exposing a tissue sample of 2 mm or less average thickness to a dimethyl sulfoxide (DMSO) solution; (b) freezing the sample of (a) in liquid nitrogen; (c) freeze-substituting the sample of (b); and (d) adding an embedding resin, such as an acrylate and methacrylate resin, which is compatible with temperatures of −60° C. to −80° C. to the sample of (c), and polymerizing the resin.

In some embodiments, the sample is previously subjected to perfusion fixation with a light fixative, or is taken from a tissue or organ that has been subjected to perfusion fixation with a light fixative. Thus, while the sample is subjected to chemical fixation, the extent of crosslinking in the sample is maintained at a minimal level by using a light fixative, such as paraformaldehyde, and at a relatively low concentration, such as 1-4% paraformaldehyde, compared to a strong fixative such as glutaraldehyde. In some embodiments, the light fixative is 2-4% paraformaldehyde. In some embodiments, it is 2% paraformaldehyde. In some embodiments, it is 3% paraformaldehyde. In some embodiments, it is 4% paraformaldehyde. In some embodiments, the perfusion fixation does not comprise glutaraldehyde or osmium tetroxide. In some embodiments, the tissue sample has not been high pressure frozen.

In some embodiments, the tissue sample to be cryoprotected has an average thickness of from 0.4 mm to 2 mm, such as 0.4 to 1.5 mm, 0.5 to 2 mm, 0.5 to 1.5 mm, 0.8 to 1.2 mm, 0.5 to 1.0 mm, 0.4 mm to 1.0 mm, 1.0 to 2 mm, 1.0 to 1.5 mm, or 1.5 to 2 mm. In some embodiments, the average thickness is 0.8 to 1.2 mm. In some embodiments it is 1 mm. In some embodiments, the sample has not been prepared by vibratomy, and/or has been manually prepared or sliced, for example, to an average thickness of 2 mm or less. In some embodiments, the sample has both been subjected to chemical fixation, such as perfusion fixation with a light fixative, and also has been prepared in the thicknesses described above.

The DMSO solution used for the cryoprotection may, for example, be 35-70% DMSO, such as 40-60% DMSO, 40-50% DMSO, 50-60% DMSO, 40%, 45%, 50%, 55%, or 60% DMSO. In some embodiments, the DMSO solution is 50% DMSO. In some embodiments, the DMSO solution is exposed to the tissue sample for at least 1 hour, such as for 2, 4, 8, 10, 12, or 18 hours, or overnight. In some embodiments, the exposure to the DMSO solution is performed at low temperature, such as at 2-8° C. or at 4° C. In some embodiments, the sample been subjected to chemical fixation, such as perfusion fixation with a light fixative, has been prepared in the thicknesses described above, and has been exposed to a DMSO solution with a DMSO concentration range described above.

Following cryoprotection in the DMSO solution, the sample may be frozen in liquid nitrogen or in an equivalent method of super-cooling the sample. In some cases, for example, the samples with thickness of 2 mm or less on average may placed onto a surface suitable for being dipped into liquid nitrogen, such as a relatively flat surface such as a plate, slide, chip or tray that is stable in the liquid nitrogen, and then dipped into the liquid nitrogen. In some cases, the surface is a copper surface.

Once the samples are frozen in liquid nitrogen, freeze substitution may take place to remove free water in the samples by effectively dissolving it with an organic solvent. In some embodiments, freeze substitution is conducted by exposing the samples, which remain frozen at −60 to −80° C., to solvents such as acetone, isopropanol, or methanol. In some embodiments, freeze substitution is conducted in acetone, i.e. 100% acetone. Thus, in some embodiments, the freeze substitution is conducted in a solution consisting essentially of acetone. In some cases, the solvent used for the freeze substitution, such as acetone, does not comprise heavy metal stains, such as uranyl acetate or osmium tetroxide. In other cases, the 100% acetone is mixed with a small amount of other substances, such as uranyl acetate and/or osmium tetroxide, such as in some cases 0.01-2% uranyl acetate, 0.01-1% uranyl acetate, 0.01-0.1% uranyl acetate, 0.05-1% uranyl acetate, 0.05-0.1% uranyl acetate, 0.1-0.5% uranyl acetate, 0.1-0.2% uranyl acetate, 0.1% uranyl acetate, or 0.2% uranyl acetate. In some cases a small amount of osmium tetroxide is added, such as 0.001% to 0.01%, or 0.001-0.002%. In some cases, the freeze substitution takes place at −60 to −80° C. for at least 1 hour up to one week, for example for at least 12 hours to 96 hours, or from 48-96 hours. Freeze substitution and very low temperature processing, as used herein, allows for preservation of ultrastructure, omits the need for strong fixatives such as glutaraldehyde (GA) and osmium tetroxide (OsO4), allows for retention of GFP fluorescence, preservation of antigens, and reduced protein, lipid, and DNA/RNA extraction compared to other methods. Without being bound to any particular mechanism, freeze substitution relies on the principle that frozen water found in biological samples can be dissolved and replaced by an organic solvent, such as acetone, methanol, or isopropanol, to name a few examples. Without being bound to any particular mechanism, it is believed that at very low temperatures, such as −80° C., the organic solvent, which remains liquid, preferentially dissolves “free unbound” water and tends to leave the tighter bound hydration shell (“molecularly bound water”) of biopolymers intact, thus ensuring that the biopolymers remain properly folded. The hydration shell is believed to be essential for proper folding and assembly of biopolymers. Therefore, preservation of the hydration shell during low temperature dehydration helps in preserving molecular structure, ultrastructure, and antigenicity of the sample.

Following freeze substitution, the sample is then exposed to an embedding resin, such as an acrylate and methacrylate resin, that is compatible with the −60 to −80° C. temperature used to store the samples, such as Lowacryl® HM23, which is a non-polar resin, or Lowacryl® K11M, which is a polar resin. For example, in some embodiments, the resin material may penetrate the sample while the sample is maintained at those low temperatures. The embedding resin can then be polymerized according to the manufacturer's instructions. For example, in some embodiments, the resins may be polymerized by exposure to UV light, such as 360 nm light.

Such resin embedded tissues, as used herein, have several advantages, including forming stable and solid tissue blocks, being able to be stored for months or years, easy sectioning and potential for serial sectioning, being stable under potentially harsh antigen retrieval conditions, easier handling for complex applications such as CLEM, quantitative labeling on a nm-flat surface, being compatible with on-section fluorescence and/or immunogold labeling, and having an appearance similar to standard morphology transmission electron micrography (TEM) images.

In some embodiments, following polymerization of the resin, the sample may be further prepared for imaging. For example, in some embodiments, appropriate stains may be added for either or both of fluorescence or electron microscopy imaging, such as fluorescent dyes or tags, or heavy metal stains for electron microscopy, such as osmium tetroxide, uranyl acetate, and lead citrate, and others. In some cases, the sample may be further sectioned for imaging, such as being cut or sliced into sections with an average thickness of less than 1 mm, such as 0.5 mm, or smaller, such as 100-1000 nm, 300-1000 nm, 400-600 nm, 400 nm, 500 nm, or 600 nm. In some cases, the sample, or a section of the sample, may then be placed on an imaging plate or slide for imaging by fluorescence and/or electron microscopy.

Accordingly, in further embodiments of the present disclosure, the methods include methods of performing fluorescence and/or electron microscopy imaging on samples prepared as described herein. Examples of electron microscopy, for instance, include CLEM, BSE-SEM, and immunogold EM. In some cases, a sample prepared as described herein is capable of distinguishing the location of a large molecule in the tissue sample, for example, a labeled drug molecule, lipid-coated drug particle, antisense drug or lipid-coated antisense drug, an antibody, a polypeptide drug, or a target of an antibody, antisense drug, or polypeptide drug. In other cases, the methods herein are capable of distinguishing the location of certain small molecules in a tissue sample herein.

### III. Kits, Systems, and Tissue Samples Prepared by the Methods

The present disclosure also includes tissue samples prepared according to methods herein. Examples include tissue samples preserved in the polymerized embedding resin and sections of such samples, which may or may not be placed onto slides or plates for storage and imaging.

The present disclosure also includes kits for performing the methods of tissue sample preparation described herein. In some embodiments, a kit comprises one or more of the reagents used in the methods described herein, such as a DMSO solution such as 40-60% DMSO, such as 40%, 45%, 50%, 55%, or 60% DMSO, a freeze substitution solution such as 100% acetone or a mixture of 100% acetone and at least one heavy metal stain such as uranyl acetate and/or osmium tetroxide, and an embedding resin, such as a polar or non-polar acrylate and methacrylate resin, wherein the resin is compatible with temperatures of −60° C. to −80° C. In some embodiments, the kit also includes a surface for dipping the tissue sample into liquid nitrogen for cooling, such as a plate, chip, or slide (i.e., one or multiple such surfaces). In some embodiments, the kit includes a fluorescence and/or electron microscopy imaging slide (i.e., one or multiple such slides). In some embodiments, the kit includes instructions for use. In some cases, the kit includes all of the above components.

The disclosure also contemplates systems for performing methods described herein. In some embodiments, a system may comprise a surface for dipping the tissue sample into liquid nitrogen for cooling, such as a plate, chip, or slide (i.e., one or multiple such surfaces) and for performing other reactions herein, such as exposure to the DMSO solution, freeze substitution of the sample, and/or adding and polymerizing the embedding resin. For instance, in some embodiments, all of the method steps may be performed in a system such that at least one of the methods is performed automatically, or such that all of the method steps are performed automatically. In some cases, the system also incorporates a kit as described above, to provide the reagents for the steps of the method, appropriate slides or surfaces on which the samples may rest during the reactions, and/or instructions for use, for example.

### EXAMPLES

The following Examples illustrate yet further embodiments of the methods herein.

### Example 1. Preparation of Colon, Colorectal Cancer, Pancreas, and Kidney Samples for Imaging

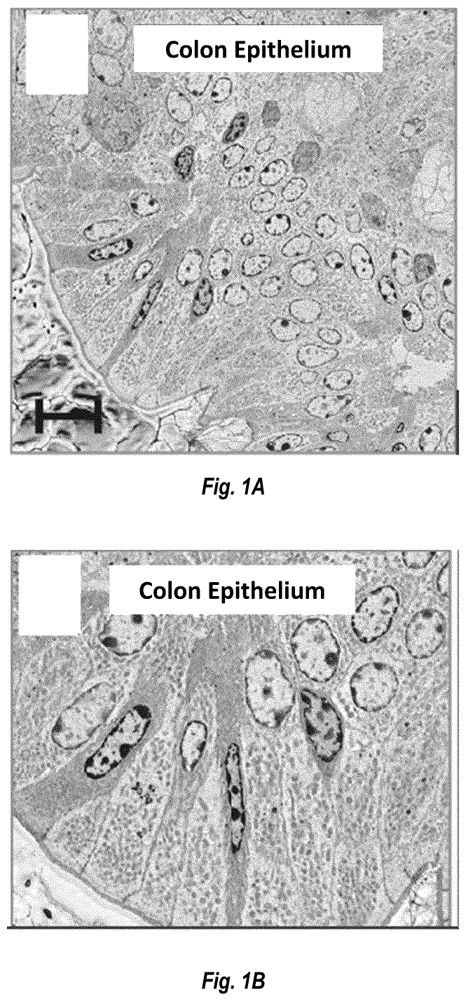

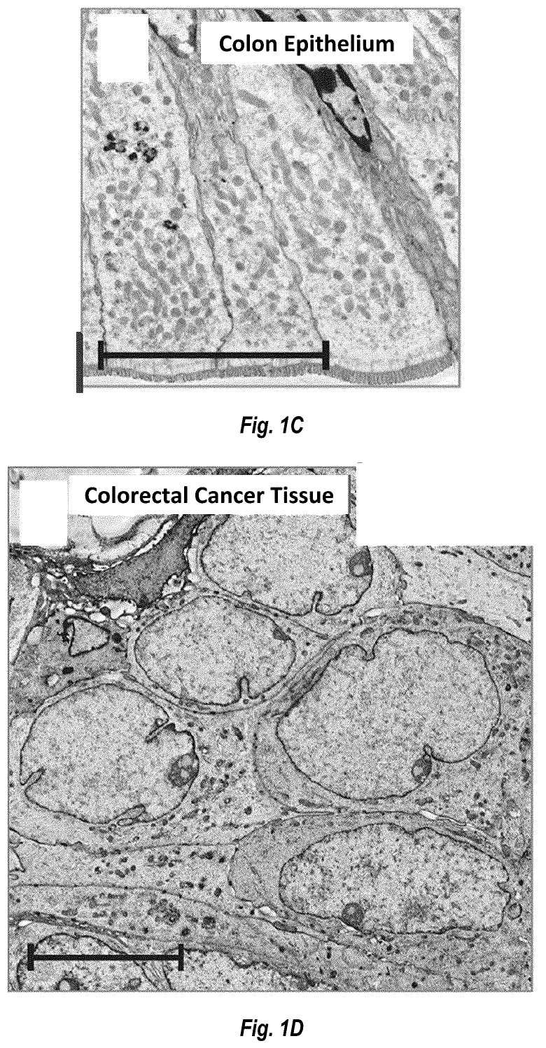

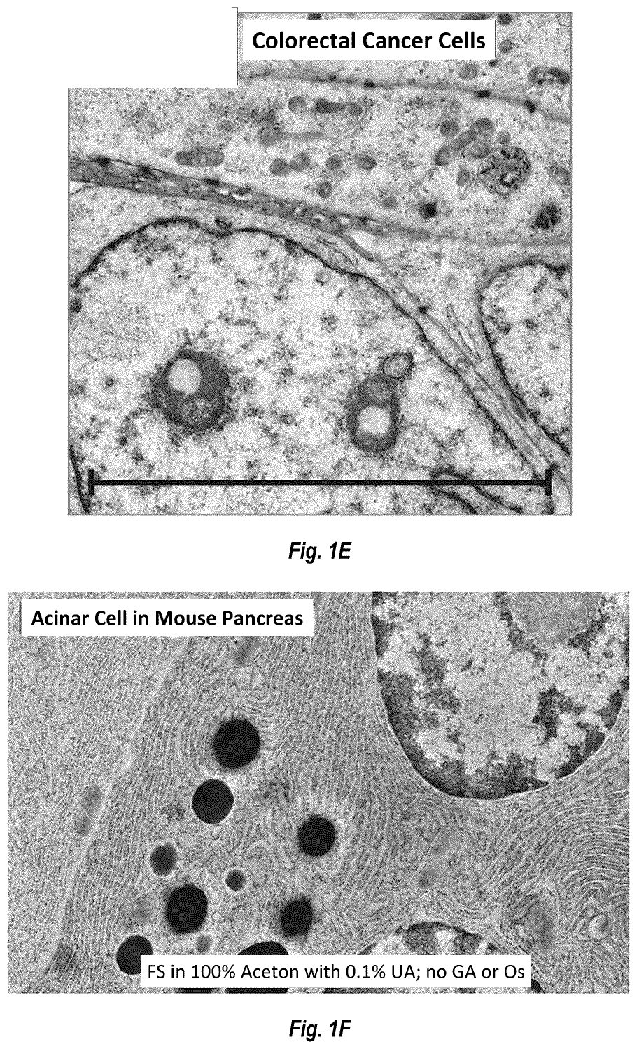

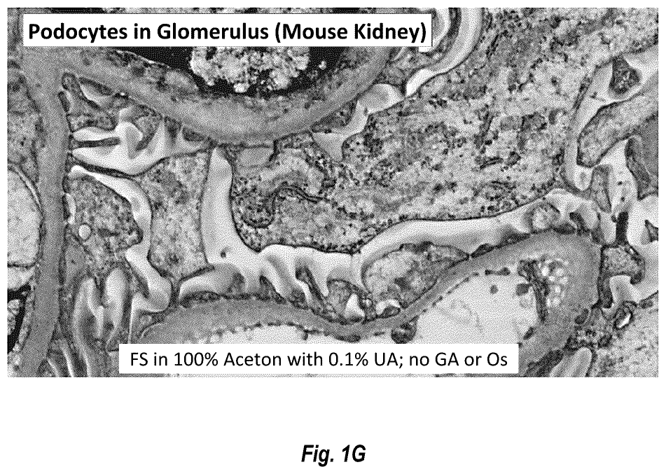

To prepare tissue samples for imaging of colon, colorectal cancer (CRC) cell, pancreas, and kidney tissues, samples were obtained in approximately 1 mm slices from larger samples that had been perfused with 4% paraformaldehyde (FPA). The 1 mm sliced samples were infiltrated with 50% DMSO at 4° C., for at least one hour to overnight, and placed on a copper plate and frozen in liquid nitrogen. Freeze substitution was performed at −80° C. in 100% acetone (with no uranyl acetate (UA), osmium tetroxide (Os), or GA (glutaraldehyde). The freeze-substituted samples were then embedded in Lowacryl® HM23 resin at −70° C. and maintained until imaged. Samples were stained with osmium tetroxide, uranyl acetate, and lead citrate before imaging in order to make ultrastructures visible. Results are shown in FIGS. 1A-E and are contrasted to samples treated similarly but with freeze substitution in 100% acetone with 0.1% uranyl acetate and no GA or osmium tetroxide, as shown in FIGS. 1F and 1G.

### Example 2. Preparation of Samples for Imaging of Anti-Insulin Antibody in Lagerhans Islet Cells

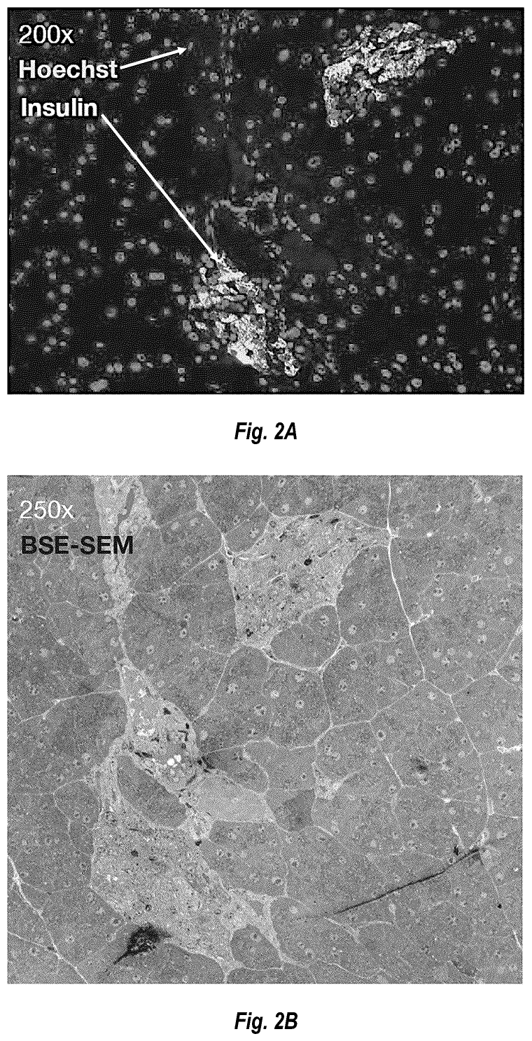

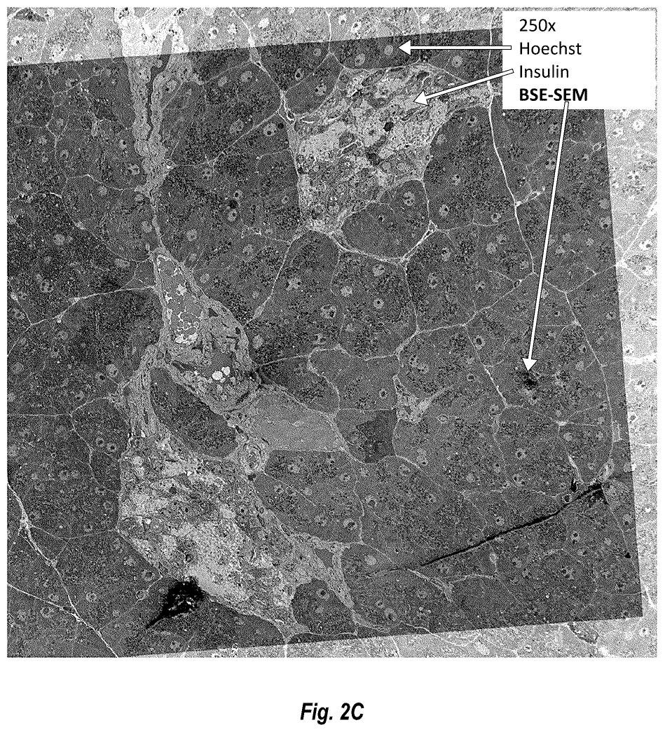

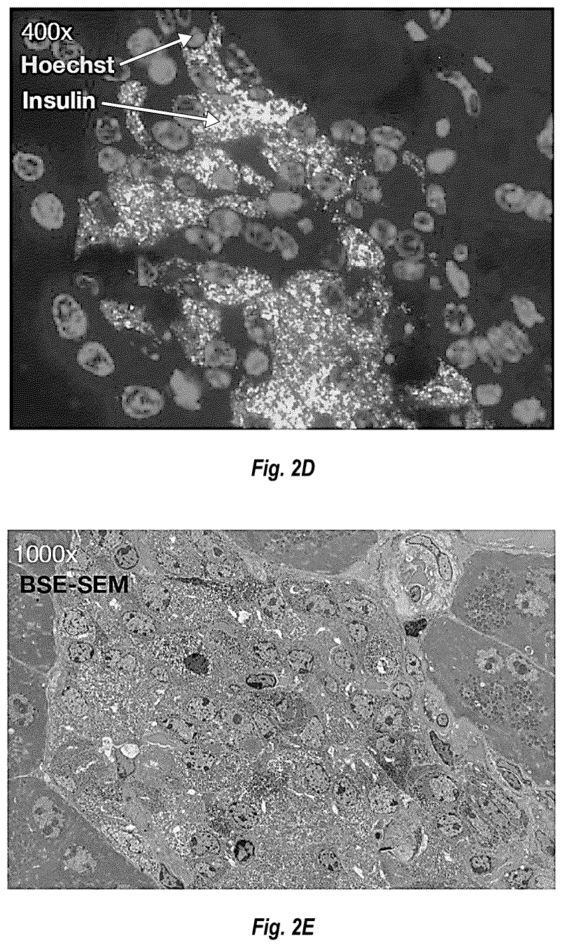

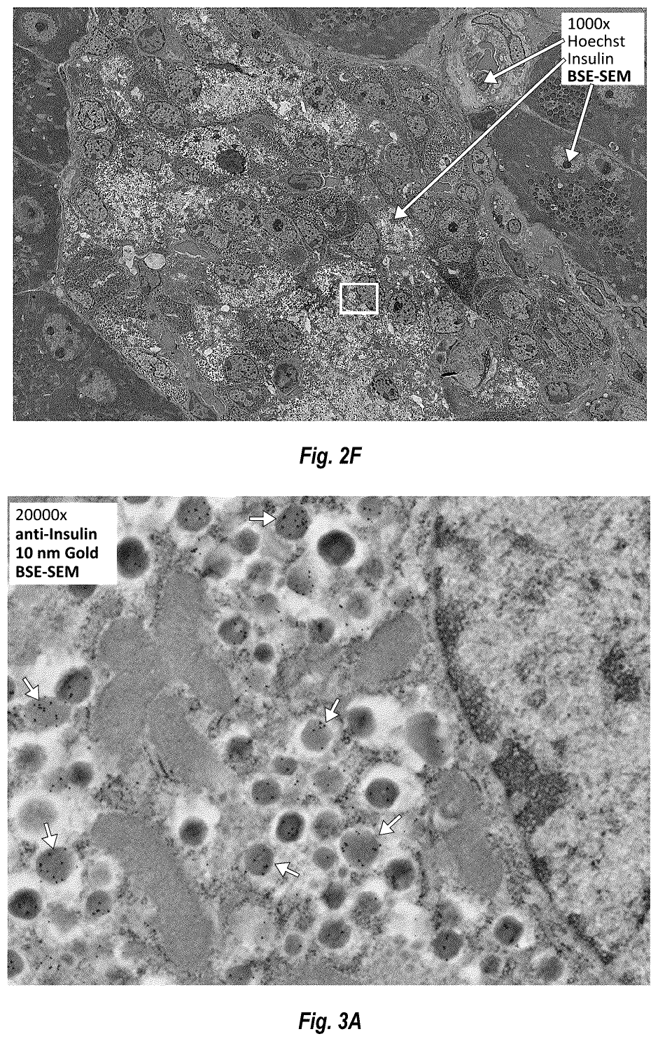

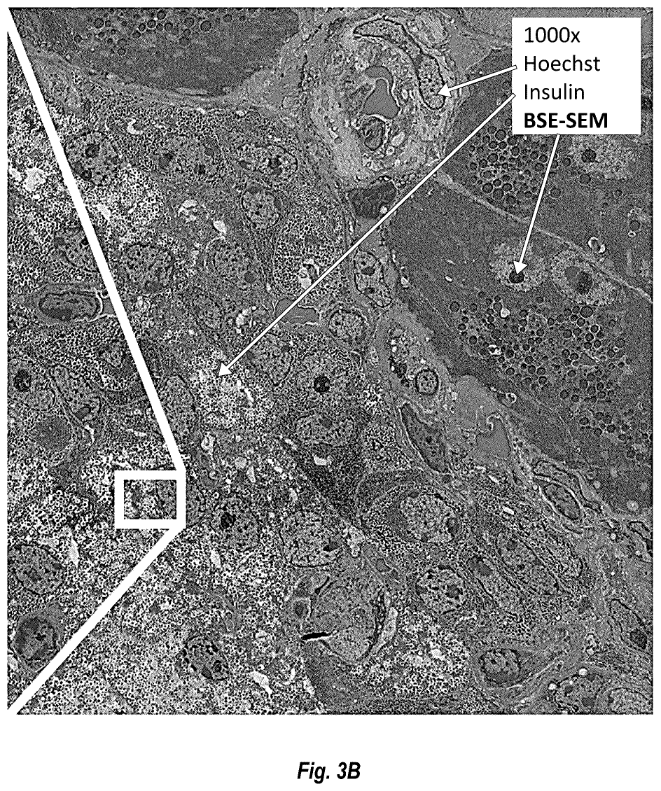

Pancreas sections (Lagerhans islets in mouse pancreas) were prepared similarly to those in Example 1, and were embedded in Lowacryl® HM23 on carbon-coated glass slides. After blocking, anti-insulin monoclonal antibody ab6995 was added, followed by anti-mouse-biotinylated secondary antibody (Jackson Immuno) and fluorescent labeled streptavidin (streptavidin A488) and a 10 nm gold conjugate (Invitrogen), in order to stain the anti-insulin antibody with both fluorescence and gold. Hoechst staining was applied to the samples to provide contrasting fluorescence to the anti-insulin antibody stain. Osmium tetroxide, uranyl acetate, and lead citrate were also added to the sample to visualize cellular structures in electron microscopy. FIG. 2A shows a fluorescence image of the sample at 200× magnification, with the fluorescent stained antibody showing as light-colored marks. A 250× BSE-SEM image (by Zeiss Gemini 300) of the sample is shown in FIG. 2B, and a composite image of the fluorescent and gold-stained images is shown in FIG. 2C. Additional images are shown in FIGS. 2D-2F and FIGS. 3A-3B, taken at higher magnification levels.

### Example 3. Preparation of Samples for Imaging of Oligonucleotide Nanoparticles in Cells

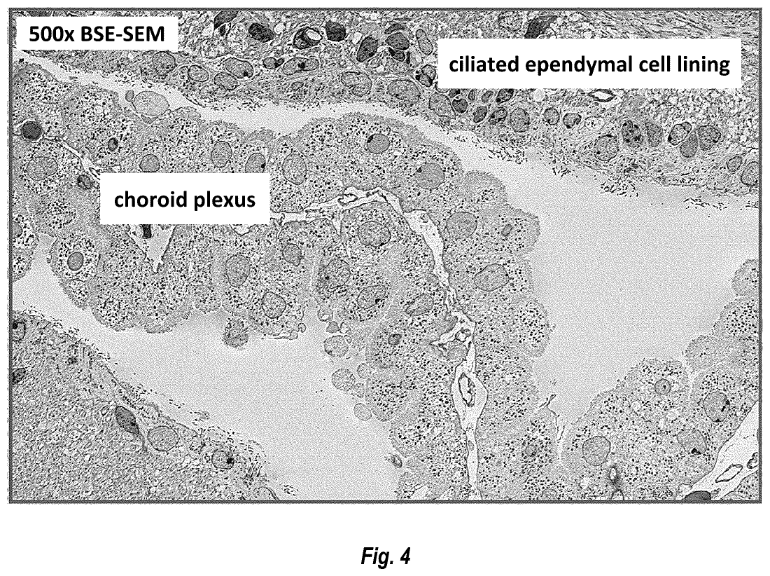

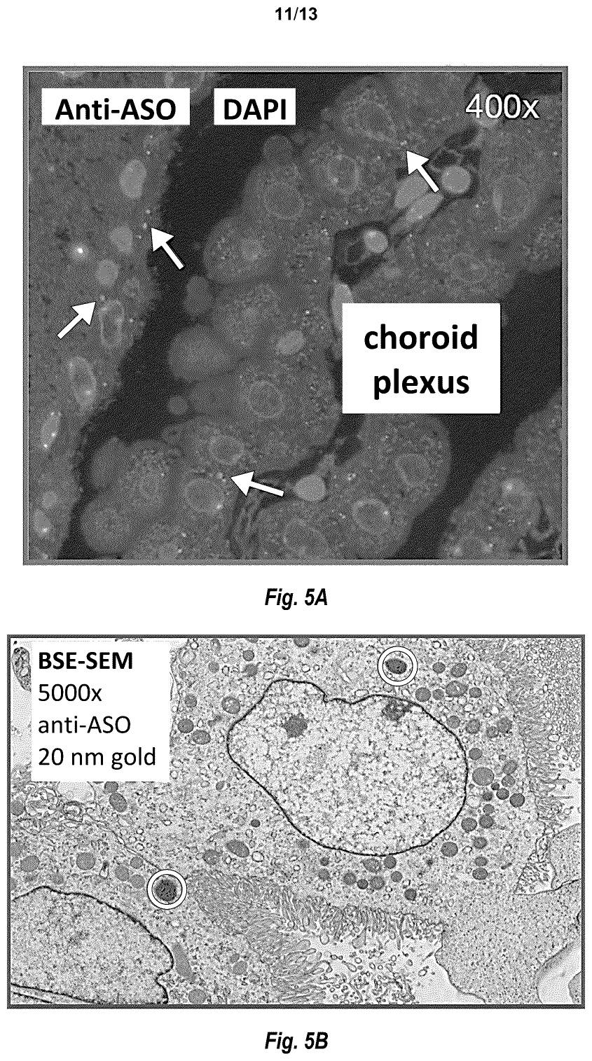

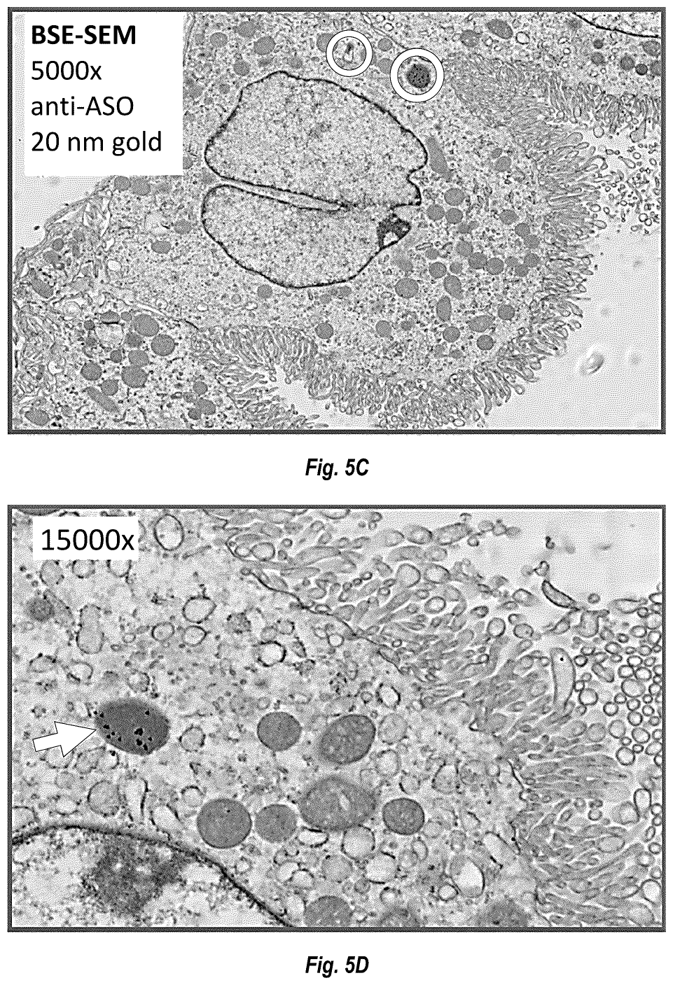

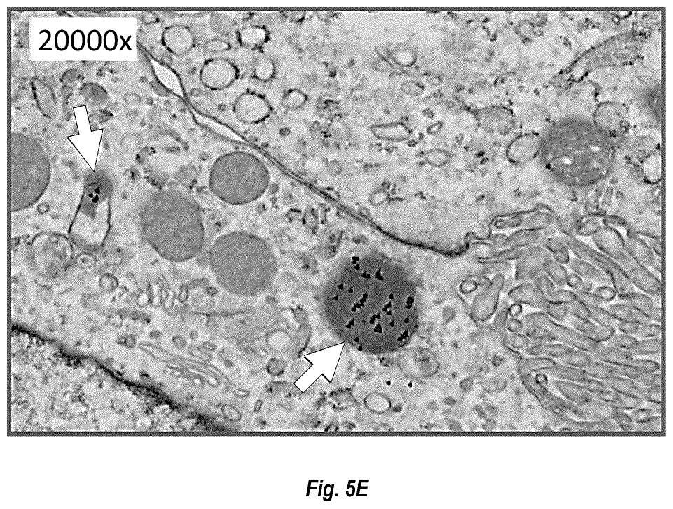

Allele specific oligonucleotide nanoparticles (ASO nanoparticles) have been explored as potential therapeutics. FIGS. 4 and 5A-5E show images from intracerebroventricular (ICV) injection of ASO nanoparticles into mouse brains in order to address which tissues, cells and organelles the ASO nanoparticles accumulate and whether encapsulation of ASOs into lipid nanoparticles alters their uptake and localization. Brain tissue samples were processed for imaging according to methods herein. Specifically, brain tissue was fixed in 4% PFA and 0.1% GA and prepared into 1 mm thick slices, which were then trimmed to dimensions of 2×2×1 mm. The trimmed samples were freeze protected in 50% DMSO at 4° C., for at least one hour to overnight, and placed on a copper plate and frozen in liquid nitrogen, then subjected to freeze substitution in acetone with 0.5% GA, 0.01% UA, and 0.001% OsO4 for 96 hours at −80° C., washed in ethanol at −80° C., and processed into Lowacryl® HM23 resin at −70° C. BSE-SEM images of heavy metal stained 500 nm thick sections on carbon coated slides was then performed. Results are shown in FIG. 4.

FIGS. 5A-5E show detection of ASO nanoparticles in ependymal cells of the choroid plexus. Samples for imaging were divided into 500 nm sections and preblocked. Anti-ASO rabbit antibody specific to the ASO analyzed was added followed by anti-rabbit biotinylated secondary antibody (Jackson Immuno). For fluorescence microscopy, streptavidin Ax568 was added to fluorescently stain the ASO particles and DAPI stain (Invitrogen) was also added to stain nuclei. Arrows in FIG. 5A show location of ASO nanoparticles in the cells. For immunogold electron microscopy, a streptavidin-20 nm gold conjugate (Abcam) was added and OsO4, UA, LC were further added to stain cellular structures. BSE-SEM was performed with a Zeiss Gemini 300 instrument; BSD1 detector, 3 kV. Results are shown in FIGS. 5B-5E. Circles show localization of ASO nanoparticles at 5000× magnification (FIGS. 5B and 5C), while arrows depict localization of ASO particles at 15,000× or 20,000× magnification (FIGS. 5D and 5E).

The foregoing written specification is considered to be sufficient to enable one skilled in the art to practice the embodiments. The foregoing description and Examples detail certain embodiments and describes the best mode contemplated by the inventors. It will be appreciated, however, that no matter how detailed the foregoing may appear in text, the embodiment may be practiced in many ways and should be construed in accordance with the appended claims and any equivalents thereof.

What is claimed is:

1. A method of cryoprotecting a tissue sample, comprising:
a) Exposing a tissue sample of 2 mm or less average thickness to a dimethyl sulfoxide (DMSO) solution;
b) Freezing the sample of (a) in liquid nitrogen;
c) Freeze-substituting the sample of (b); and
d) Adding an embedding resin compatible with temperatures of −60° C. to −80° C. to the sample of (c), and polymerizing the resin.

2. The method of claim 1, wherein tissue sample of (a) has an average thickness of 1.5 mm or less.

3. The method of claim 1, wherein the tissue sample of (a) has an average thickness of 1.0 mm or less.

4. The method of claim 1, wherein the tissue sample of (a) has an average thickness of 0.4 mm to 1.5 mm.

5. The method of any one of claims 1-4, wherein the tissue sample of (a) has an average thickness of at least 0.5 mm (such as, of 0.5-2 mm, of 0.5-1.5 mm, or of 0.5-1 mm).

6. The method of any one of claims 1-5, wherein the tissue sample of (a) has not been prepared via vibratomy, and/or wherein the sample has been manually prepared or sliced.

7. The method of any one of claims 1-6, wherein the tissue sample has been perfused with a light fixative, or has been obtained from a tissue or organ that has been perfused with a light fixative, and/or wherein the tissue sample has not been high pressure frozen.

8. The method of claim 7, wherein the light fixative comprises 14% paraformaldehyde.

9. The method of any one of claims 1-8, wherein the sample of (b) is freeze-substituted with an acetone solution, such as 100% acetone, or a mixture of 100% acetone and at least one heavy metal stain such as uranyl acetate and/or osmium tetroxide.

10. The method of claim 9, wherein the sample of (b) is freeze-substituted in a mixture of 100% acetone and 0.01-0.2% uranyl acetate, and optionally osmium tetroxide, such as 0.001% to 0.002% osmium tetroxide.

11. The method of any one of claims 1-10, wherein the embedding resin is a non-polar resin.

12. The method of any one of claims 1-10, wherein the embedding resin is a polar resin.

13. The method of any one of claims 1-12, wherein the embedding resin is an acrylate and methacrylate resin and/or wherein the resin is polymerized by ultraviolet light, such as at 360 nm wavelength.

14. The method of any one of claims 1-13, further comprising staining the sample of (d), for example, with a fluorescent stain and/or a heavy metal stain, such as one or more of osmium, lead, or gold stains.

15. The method of any one of claims 1-14, wherein the method is conducted at atmospheric pressure.

16. The method of any one of claims 1-15, wherein the sample is a tissue block from a solid organ.

17. The method of any one of claims 1-6 or 8-16, wherein the method further comprises preparing the tissue sample of 2 mm or less average thickness by obtaining a tissue sample or organ that has been perfused with a light fixative and slicing the tissue sample or organ to an average thickness of 2 mm or less.

18. The method of any one of claims 1-6 or 8-17, wherein the method further comprises perfusing a tissue sample or organ in a light fixative and slicing the tissue sample or organ to an average thickness of 2 mm or less prior to step (a).

19. A method of imaging a tissue sample or a section of a tissue sample, wherein the tissue sample has an average thickness of 2 mm or less and has been prepared by a process comprising (a) exposing the sample to a dimethyl sulfoxide (DMSO) solution, (b) freezing the sample of (a) in liquid nitrogen, (c) freeze-substituting the sample of (b), and (d) adding an embedding resin compatible with temperatures of −60° C. to −80° C. to the sample of (c) and polymerizing the resin; the method comprising: performing electron microscopy on the tissue sample or on the section of the tissue sample.

20. The method of claim 19, wherein tissue sample of (a) has an average thickness of 1.5 mm or less.

21. The method of claim 19, wherein the tissue sample of (a) has an average thickness of 1.0 mm or less.

22. The method of claim 19, wherein the tissue sample of (a) has an average thickness of 0.4 mm to 1.5 mm.

23. The method of any one of claims 19-22, wherein the tissue sample of (a) has an average thickness of at least 0.5 mm (such as, of 0.5-2 mm, of 0.5-1.5 mm, or of 0.5-1 mm).

24. The method of any one of claims 19-23, wherein the tissue sample of (a) has not been prepared via vibratomy, and/or wherein the sample has been manually prepared or sliced.

25. The method of any one of claims 19-24, wherein the tissue sample has been perfused with a light fixative, or has been obtained from a tissue or organ that has been perfused with a light fixative, and/or wherein the tissue sample has not been high pressure frozen.

26. The method of claim 25, wherein the light fixative comprises 1-4% paraformaldehyde.

27. The method of any one of claims 19-26, wherein the sample of (b) is freeze-substituted with an acetone solution, such as 100% acetone, or a mixture of 100% acetone and at least one heavy metal stain such as uranyl acetate and/or osmium tetroxide.

28. The method of claim 27, wherein the sample of (b) is freeze-substituted in a mixture of 100% acetone and 0.01-0.2% uranyl acetate, and optionally osmium tetroxide such as 0.001% to 0.002% osmium tetroxide.

29. The method of any one of claims 19-28, wherein the embedding resin is a non-polar resin.

30. The method of any one of claims 19-28, wherein the embedding resin is a polar resin.

31. The method of any one of claims 19-30, wherein the embedding resin is an acrylate and methacrylate resin and/or wherein the resin is polymerized by ultraviolet light, such as at 360 nm wavelength.

32. The method of any one of claims 19-31, wherein the process of (a)-(d) further comprises staining the sample of (d), for example, with a fluorescent stain and/or a heavy metal stain, such as one or more of osmium, lead, or gold stains.

33. The method of any one of claims 19-32, wherein the method is conducted at atmospheric pressure.

34. The method of any one of claims 19-33, wherein the sample is a tissue block from a solid organ.

35. The method of any one of claims 19-34, wherein the electron microscopy is correlated light and electron microscopy (CLEM) or immunogold electron microscopy.

36. The method of any one of claims 19-35, wherein the method is capable of distinguishing the location of a drug molecule in or adjacent to a cell in the sample, such as, for example, a lipid-coated drug, an antisense drug, an antibody drug, a polypeptide drug, or a small molecule drug.

37. The method of any one of claims 19-36, wherein the method is performed on a section of the tissue sample with an average thickness of 300 nm to 1000 nm, such as 500 nm.

38. The method of any one of claims 19-37, further comprising performing fluorescence microscopy on the sample or on a section of the sample.

39. The method of any one of claims 1-38, wherein the DMSO solution comprises 40-60% DMSO, such as 40%, 45%, 50%, 55%, or 60% DMSO.

40. A tissue sample prepared by the method of any one of claims 1-18 or 39.

41. A kit for performing the method of any one of claims 1-18 or 39, comprising at least one of: a DMSO solution, a freeze substitution solution such as 100% acetone or a mixture of 100% acetone and at least one heavy metal stain such as uranyl acetate and/or osmium tetroxide, and an embedding resin, such as a polar or non-polar acrylate and methacrylate resin, wherein the resin is compatible with temperatures of −60° C. to −80° C., and optionally further comprising at least one of: a plate or chip for immersing the tissue sample in liquid nitrogen, a fluorescence and/or electron microscopy imaging slide, and instructions for use.

42. A system for performing the method of any one of claims 1-18 or 39, wherein the system automatically or semiautomatically performs the steps of:
a) Exposing a tissue sample of 2 mm or less average thickness to a dimethyl sulfoxide (DMSO) solution;
b) Freezing the sample of (a) in liquid nitrogen;
c) Freeze-substituting the sample of (b); and
d) Adding an embedding resin compatible with temperatures of −60° C. to −80° C. to the sample of (c), and polymerizing the resin.

43. The system of claim 42, wherein the system performs steps (a) to (d) on at least one plate or chip.
